(19) United States
(12) Patent Application Publication
(10) Pub. No.: US 2005/0258732 A1
(43) Pub. Date: Nov. 24, 2005

(54) Horizontal deflection coil

(75) Inventor: Dong-Chol Shin, Kyunggi-do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/933,609

(22) Filed: Sep. 2, 2004

(30) Foreign Application Priority Data
May 19, 2004 (KR) 2004-35629

(51) Int. Cl. H01J 29/70; H01J 29/46

(52) U.S. Cl. 313/440; 313/441

(57) ABSTRACT

Provided is a horizontal deflection coil of a deflection yoke in which the shape of the horizontal deflection coil is changed, thereby adjusting a screen wire distribution regardless of a middle wire distribution and constantly maintaining the shape of the middle portion of the horizontal deflection coil.

### BACKGROUND OF THE INVENTION

1. Field of the Invention

The present invention relates to a horizontal deflection coil applied to a deflection yoke, and more particularly, to a horizontal deflection coil of a deflection yoke in which the shape of the horizontal deflection coil is changed, thereby adjusting a screen wire distribution regardless of a middle wire distribution.

2. Description of the Related Art

Generally, a Braun tube of a television set employs an electronic deflection technique. To irradiate electron beams, it is essentially required to apply horizontal and vertical magnetic fields from a neck portion of the Braun tube. Two coils basically disposed at a right angle so as to form such deflection magnetic fields are called ‘horizontal and vertical deflection coils’, and a combination of both the deflection coils and a ferrite core is called ‘deflection yoke.’

The deflection yoke can be classified into three types, i.e., a saddle-saddle type in which both deflection coils are designed in a saddle-shaped oblique line, a semi-toroidal type in which a horizontal is formed in a saddle type and a vertical deflection coil is wound directly on a ferrite, a toroidal-toroidal type in which both deflection coils are wound on a ferrite. The present invention is applied to a fabrication of a horizontal coil using a winder, and more particularly, to a fabrication of a saddle type deflection coil.

The vertical and horizontal deflection coils are used for exactly forming a picture on a screen of a Braun tube by applying a deflection magnetic field to an electron beam irradiated from the neck portion. However, in the above method, misconvergence phenomenon that a picture is shown distorted on the screen. To correct the misconvergence, various variables such as the number of turns of the horizontal and vertical deflection coils, a size of a window and a variation of a position, an installation of a magnet and the like, are considered. Among these variables, correction and change of the vertical and horizontal deflection coils directly applying the deflection magnetic fields to the electron beam are mainly used to correct the misconvergence.

FIG. 1 is a side sectional view of a general deflection yoke, and shows a deflection yoke 10 installed on a z-axis of a cathode ray tube 1 having a screen surface 1a and an electron gun 1c respectively formed at a front side and a rear side thereof.

Referring to FIG. 1, the deflection yoke 10 includes a pair of coil separators 13, which are shaped in a bugle and are symmetric to left and right sides, a horizontal deflection coil 12 and a vertical deflection coil piled on an inner circumference and an outer circumference of the coil separators 13, for forming a horizontal magnetic field and a vertical deflection magnetic field, and a ferrite core 15 configured to enclose an outer circumference of the vertical deflection coil 14, for reinforcing the vertical deflection magnetic field.

Of course, the horizontal deflection coil 12 deflects an electron beam positioned inside the electron gun part 1c in a horizontal direction, and the vertical deflection coil 14 deflects the electron beam in a vertical direction.

Referring to FIG. 2, the horizontal and vertical deflection coils include a screen bent portion 12a having an outward shape, and a neck bent portion 12c respectively formed at a front end and a rear end. However, since deflection magnetic fields generated by the screen bent portion 12a and the neck bent portion 12c are too weak to affect the deflection of the electron beam, they are generally called an ineffective bent area. It is a middle portion 12b of the deflection coil to substantially generate a deflection magnetic field.

These deflection coils 12 and 14 are manufactured by a winder for a deflection yoke shown in FIG. 3. FIG. 3 is a perspective view of a winder for a deflection yoke according to a conventional art, and FIG. 4 is a schematic perspective view of a mold part depicted in FIG. 3.

As shown in the drawings, the winder for a deflection yoke has a female mold 20 and a male mold 30 coupled to each other, and includes winding parts 24 and 34 where the deflection coils 12 and 14 are manufactured, and guide parts 26 and 36 formed at both sides of the winding parts 24 and 34, for guiding a coil to the winding parts 24 and 34.

At this point, the winding part 24 of the female mold 20 is made in a concave shape and the winding part 34 of the male mold 30 is made in a convex shape, such that the winding parts 24 and 34 can be coupled to each other.

Meanwhile, a plurality of turning pins 23 for guiding a winding of the coil are installed at a front side of the winding part 24 of the female mold 20 such that the deflection coil is formed with a specific shape. The turning pins 23 are spaced apart a predetermined distance from each other.

Of course, the mold shown in FIG. 4 corresponds to the female mold 20 of FIG. 3. As shown in FIG. 4, the female mold 20 includes the screen portion 22 at a front side thereof, a neck part at a rear side thereof, and the winding part 24 formed between the screen portion 22 and the neck portion 25 and having the concave shape.

The turning pins 23 of the screen portion 22 are formed symmetric to the left and right sides. Referring to the left sided turning pins 23, the turning pins 23 are sequentially formed from an upper side to a lower side. A coil wire is wound by being via the turning pins 23 and communicating between the screen portion 22 and the neck portion 25. In other words, the coil is wound by being via the turning pins 23 as a start point and communicating between the screen portion 22 and the neck portion 25. Thus, since the coil is wound from the turning pins 23 that is the start point of the winding, the turning pins 23 determines a whole shape of the deflection coil.

In other words, the turning pins 23 induce the winding of the coil such that the coil is wound at a predetermined shape. As a result, the coil wound via the turning pins 23 is manufactured in the shape of the deflection coils 12 and 14 shown in FIG. 2.

In detail, the screen bent portion 12a, the middle portion 12b, the neck bent part 12c of the deflection coils 12 and 14 are provided at the winding part 24. A shape of the middle portion 12b is determined depending on an angle at which the turning pins 23 are installed.

In the meantime, non-described symbol “W” denotes a welding portion. The welding portion is to vary the deflection magnetic field of the middle portion 12b of the deflection coils 12 and 14. The shape of the middle portion 12b of the deflection coils 12 and 14 is deformed depending on an adhering shape of a weldment, thereby varying the deflection magnetic field.

In the meantime, FIG. 5 is a view illustrating a construction and a magnetic field of the deflection yoke employing the deflection coils 12 and 14, which are formed using the conventional winder for the deflection yoke. Particularly, FIG. 5 illustrates a sectional view along the line A-A′ and a conceptive view of the deflection magnetic field of the deflection yoke of FIG. 1, and shows a deflection magnetic fields illustrating deflection states at low and left sides.

In the deflection yoke 10 shown in FIG. 5, the horizontal and vertical deflection coils 12 and 14 are piled at internal and external sides of the coil separator 13. The ferrite core 15 is piled on an outer circumference of the vertical deflection coil 14. Blue (B), green (G), red (R) electron beams are arranged in a lateral direction at a center of the deflection yoke 10. When a current is applied to the deflection yoke 10, a deflection magnetic field (along the line A-A′) is generated according to Fleming's right hand rule. The generated deflection magnetic field causes the deflection force to be generated at lower and left sides according to Fleming's left hand rule.

At this time, the deflection magnetic field, which is shown at the left and right sides of the deflection yoke 10, is a horizontal deflection magnetic field (HB) for generating the left-side deflection force, and has a shape of a pin cushion such as a spool. Additionally, the deflection magnetic fields of upper and lower sides are vertical deflection magnetic field (VB) for generating a lower-side deflection force. The deflection magnetic fields are shaped to allow both side portions marked as a dotted line to be in proximity to the B, G and R electron beams closer than the middle portion in the horizontal deflection magnetic field (HB).

Since the middle portions of the horizontal and vertical deflection magnetic fields (HB and VB) are in close proximity to the B and R electron beams, the B and R electron beams are deflected stronger than the G electron beam, thereby causing misconvergence on the screen as in FIG. 6.

FIG. 6 is a view illustrating a pattern of misconvergence generated on the screen in the general deflection yoke. The misconvergence will now be described with reference to FIG. 6. The screen is partitioned as a first quadrant to a fourth quadrant with respect to X-axis and Y-axis. S-points comprised of dotted lines S1 to S3 are provided at a center of each quadrant.

At this time, a characteristic of the horizontal and vertical deflection magnetic fields (HB and VB), that is, a characteristic of more strongly deflecting the B and R electron beams causes the B and R electron beams to mis-land at the S3 location, which is a middle of the screen, thereby generating a bing-shaped misconvergence.

In the meantime, the misconvergence is basically caused by the shapes of the deflection coils 12 and 14, that is, by the middle portion 12b of the deflection coils 12 and 14 at which the deflection magnetic field substantially deflecting the electron beam is generated. In other words, the shapes of the middle portion 12b of the deflection coils 12 and 14 cause the generation of the horizontal and vertical deflection magnetic fields of FIG. 5.

In detail, the deflection magnetic field, which is in close proximity to the screen bent portion 12b and the neck bent part 12c, causes the misconvergence having a characteristic of PQH and PQV (not shown) at a corner of the screen.

Additionally, with reference to the middle portion 12b shown in FIG. 2, the deflection magnetic field is generated at a ⅓ location of the screen portion 12b, which is disposed at a front end of the middle portion 12b. The deflection magnetic field causes the misconvergence having the characteristic of S3H and S3V shown in FIG. 6. These shapes of the deflection coils 12 and 14 get worse the misconvergence due to the flat and the wide-angle of the screen. The misconvergence caused by the flat and the wide-angle of the screen is in detail illustrated in FIG. 7.

FIG. 7 is a schematic conceptive view illustrating a procedure of radiating the electron beam on a screen surface of the cathode ray tube, and illustrates a radiation procedure of the electron beam on a plane. As illustrated, the B, G, R electron beams are consistent at a focus (F). However, the flat and the wide-angle of the screen cause both sides of the screen surface 1a to be far away from the focus (F) such that the B, G, R electron beam are not converged and are mis-landed at one location, thereby causing intense misconvergence.

As described above, the deflection coils 12 and 14 of the winding machine for the deflection yoke have a drawback in that the intense misconvergence is caused at the S-point, which is the middle on the screen, especially, at the S3-point.

Since the misconvergence is caused by the shape of the middle portion 12b of the deflection coils 12 and 14, the middle portion 12b of the deflection coils 12 and 14 can be deformed by welding or cutting at a “W” location of the winding part 24 of an arm-shaped mold 20, or making different the turns of the winding wire of the coil wound at a plurality of turning pins 23.

However, there is a drawback in that if the deflection coils 12 and 14 are shaped by using the welding or the cutting or by making different the turns of the winding wire, a time is not only increasingly taken for manufacturing the product due to the increasing of a work process in number, but also a cost of the product is increased. This process causes a scattering at the time of manufacture, thereby resulting in a failure of the deflection yoke.

In order to solve the above drawback of the scattering, there has been proposed a deflection-coil winder having a predetermined number of cylindrical pins to provide the screen section part having a predetermined shape for the middle portion 12b of the deflection coils 12 and 14. FIG. 8 illustrates a horizontal deflection coil provided by the cylindrical pin of the winding machine, and FIG. 9 illustrates a mold of the winder for the deflection yoke having the cylindrical pin.

The horizontal deflection coil 12 provided using the winder functions to reduce the scattering generated at the S3. FIG. 10 illustrates a side view of the horizontal deflection coil on which the wire is wound using the cylindrical pin 44. The left side of FIG. 10 represents the neck bent part 12c, and the right side of FIG. 10 represents the screen bent portion 12a. As illustrated, in case where the wire is wound using the middle cylindrical pin 44, the wire is piled, thereby causing the suspension of the wire part 43, which is piled in a reverse direction (pressed direction) of the window direction.

Further, FIG. 10 illustrates a case where the turning pin 23 of the screen portion is moved by a predetermined distance. That is, in case where the turning pin 23 of the screen portion is moved upwardly by a predetermined distance d″ as illustrated in FIG. 10, the wire part of the wire curved-surface part 42 is moved by a predetermined distance d′. Accordingly, there is a drawback in that the scattering is caused in the manufacture process, thereby not maintaining the shape of the wire part 43, and generating variance.

Furthermore, due to the above drawback, the horizontal deflection coil 12 is suspended in the press direction (arrow direction), thereby causing the middle portion 12b to have a different shape every product when the product is manufactured. Accordingly, there is a drawback in that four parts of the middle portion have the different shapes in the two horizontal deflection coils installed at the deflection coil, thereby not generating the same deflection magnetic field, and accordingly resulting in the misconvergence caused by the scattering in the manufacture process. Furthermore, there is a drawback in that the deflection magnetic field is differently generated every product, thereby causing a quality of product to be deteriorated.

Accordingly, it is required to propose a way of maintaining the middle portion to have the same shape when the coil is piled or the turning pin of the screen portion is moved. That is, it is required to propose a way in which a predetermined quantity of the coil wound using the winding machine is constantly maintained to provide a constant symmetry of left and right of the horizontal and vertical deflection coils, thereby preventing the above misconvergence.

### SUMMARY OF THE INVENTION

Accordingly, the present invention is directed to a horizontal deflection coil of a deflection yoke that substantially obviate one or more problems due to limitations and disadvantages of the related art.

An object of the present invention is to provide a horizontal deflection coil of a deflection yoke in which the shape of the horizontal deflection coil is changed, thereby adjusting a screen wire distribution regardless of a middle wire distribution.

To achieve these objects and other advantages and in accordance with the purpose of the invention, as embodied and broadly described herein, there is provided a horizontal deflection coil for a deflection yoke, comprising: a screen bent portion; a middle portion having a screen section portion for generating a main deflection magnetic field, the screen section portion including at least one wire curved-surface portion; and a neck bent portion, wherein a wire portion shaped in a letter ‘M’ or ‘W’ is piled centering on the wire curved-surface portion.

Preferably, the wire portion piled in a downward direction of the screen section portion has a groove at a middle portion thereof, the groove is formed using a cylindrical pin, and an upward support pin is used to form both sides of the wire portion.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a side sectional view of a general deflection yoke;

FIG. 2 is a plane view of a deflection coil of the deflection yoke depicted in FIG. 1;

FIG. 3 is a perspective view of a winder for a deflection yoke according to a conventional art;

FIG. 4 is a schematic perspective view of a mold part depicted in FIG. 3;

FIG. 5 is a sectional view of the deflection yoke taken along the line A-A′ of FIG. 1 and is a schematic view of a deflection magnetic field;

FIG. 6 is a schematic view of a misconvergence pattern on a screen by a general deflection yoke;

FIG. 7 is a schematic view illustrating an irradiation of an electron beam on a screen of a CRT;

FIG. 8 is a perspective view of a horizontal deflection coil having a screen section portion according to the conventional art;

FIG. 9 is a schematic perspective view of a mold of a winder used for manufacturing the horizontal deflection coil of FIG. 8;

FIG. 10 is a side sectional view of the horizontal deflection coil of FIG. 8;

FIG. 11 is a perspective view of a horizontal deflection coil according to the present invention;

FIG. 12 is a side sectional view of a horizontal deflection coil according to the present invention;

FIG. 13 is a schematic view of a winder used for manufacturing a horizontal deflection coil according to the present invention;

FIGS. 14a and 14b are perspective views of a cylindrical pin and an upward support pin; and

FIG. 15 is a perspective view of a deflection yoke provided therein with a horizontal deflection coil.

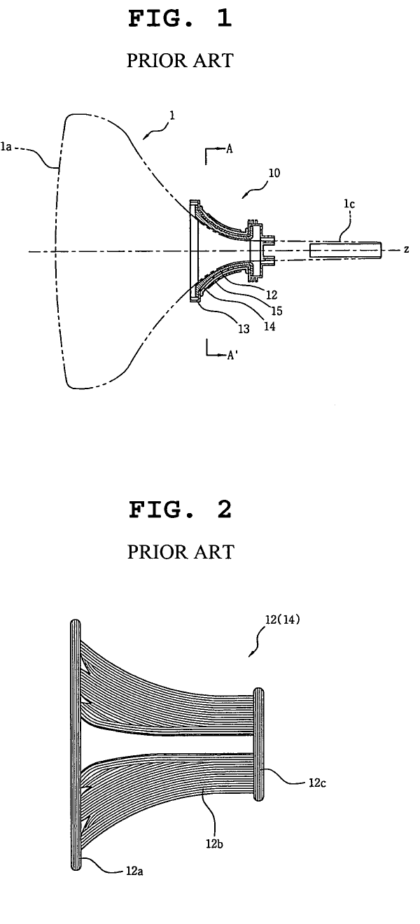

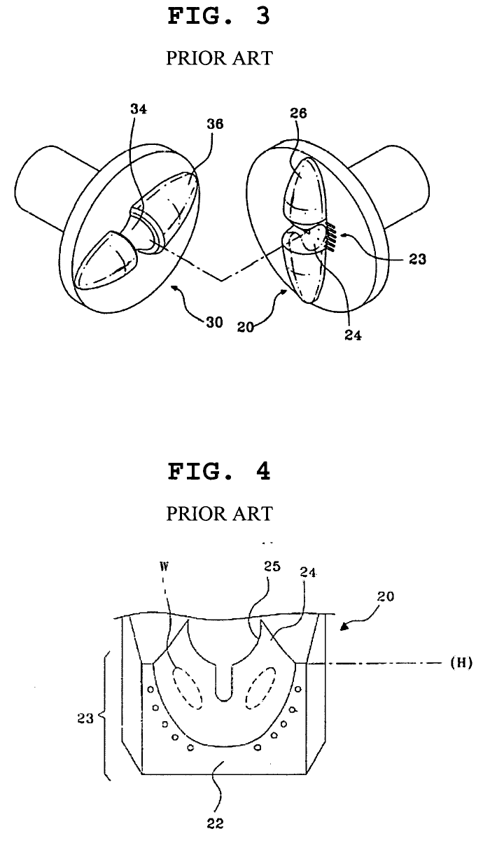

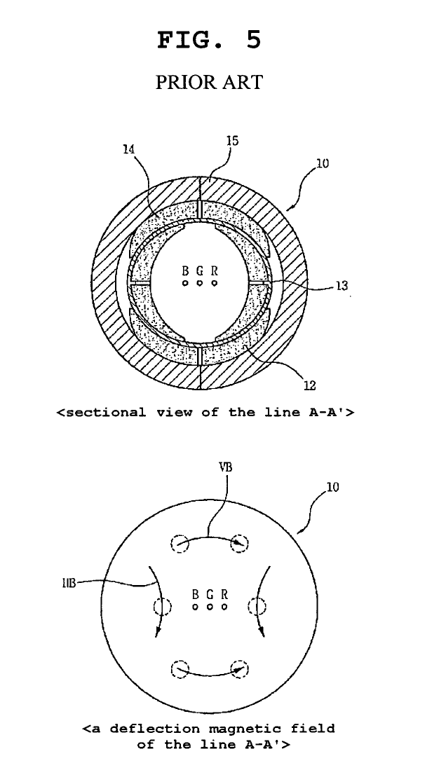

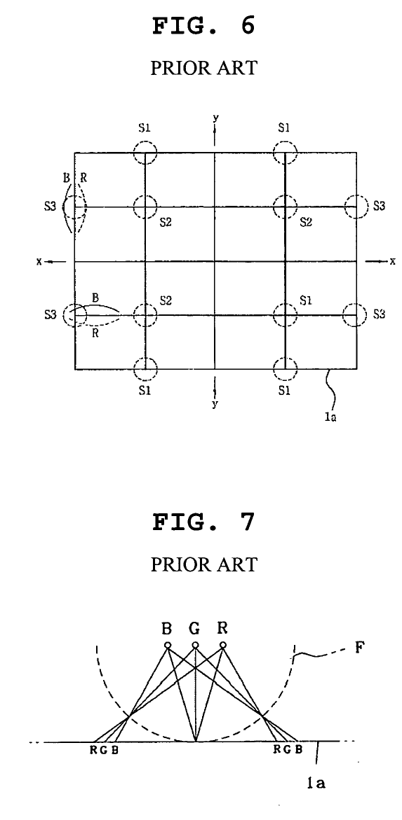

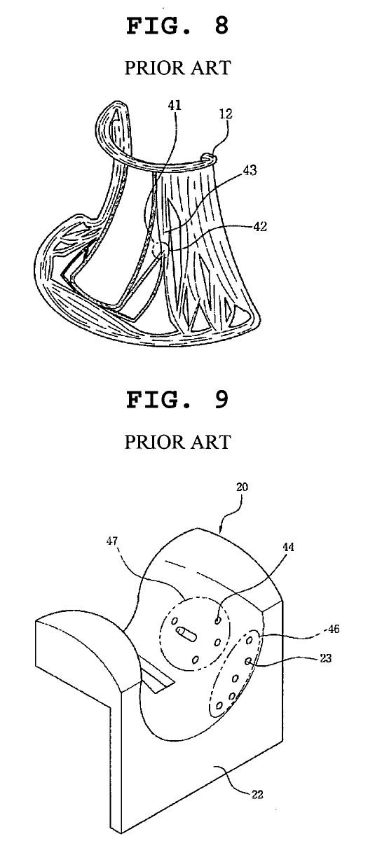

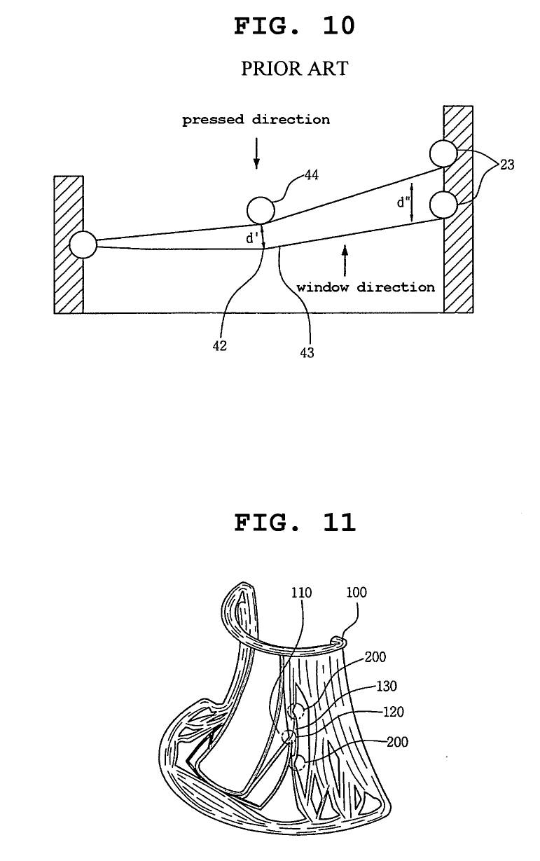

### DETAILED DESCRIPTION OF THE INVENTION

Reference will now be made in detail to the preferred embodiments of the present invention, examples of which are illustrated in the accompanying drawings.

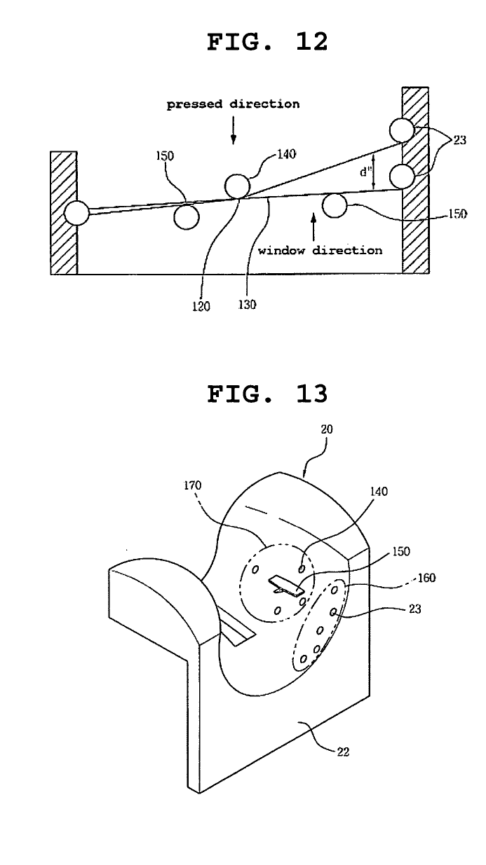

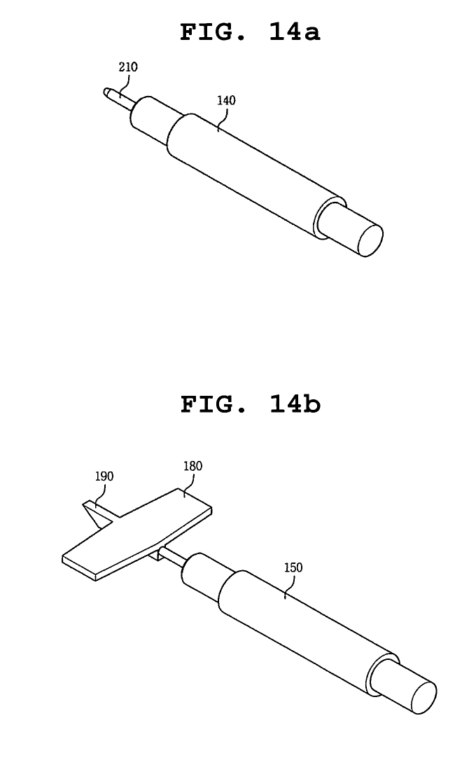

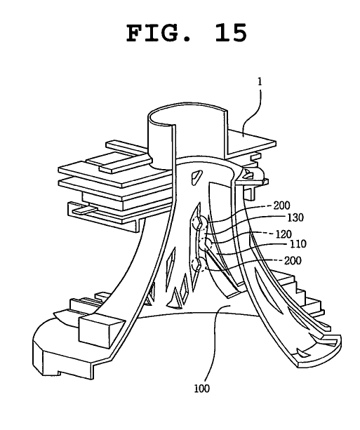

For reference, FIG. 11 is a perspective view illustrating a horizontal deflection coil according to the present invention, FIG. 12 is a side view illustrating the horizontal deflection coil wound by an upward support pin according to the present invention, FIG. 13 is a perspective view illustrating a mold of a deflection-yoke winder for winding the horizontal deflection coil according to the present invention, FIG. 14 is a perspective view illustrating a cylindrical pin and the upward support pin, and FIG. 15 is a view illustrating the horizontal deflection coil mounted on a deflection yoke according to the present invention. For the convenience of description, the same reference numbers will be used throughout the drawings to refer to the same or like parts.

Referring to FIG. 11, the horizontal deflection coil 100 includes a screen bent portion 12a, a middle portion 12b having a predetermined screen section portion 110 for generating a main deflection magnetic field, and a neck bent portion 12c. The screen section portion 110 provided at the middle portion 12b of the horizontal deflection coil 100 has at least one wire curved-surface portion 120. A wire portion 130 can be piled in a pressed direction, centering on the wire curved-surface portion 120, and has a constant shape of a ‘M’-shape or a ‘W’-shape. The ‘M’-shaped or ‘W’-shaped curved-surface part is denoted by a reference numeral 200.

All of the neck bent portion 12c and the screen bent portion 12a of the horizontal deflection coil 100 according to the present invention are to generate a magnetic field of the deflection coil, but they belong to an ineffective bent area not substantially affecting the magnetic field of the deflection yoke due to the weakness of the magnetic field. IT is the middle portion 12b to substantially generate the main deflection magnetic field. In order to enhance the deflection magnetic field, a cylindrical pin 140 having a deformed shaped is used to form the screen section portion 110, thereby correcting the affection of the magnetic field depending on the horizontal deflection coil 100. That is, the screen section portion 100 is formed to determine whether more wires are provided at any side, centering on the middle portion of the horizontal deflection coil 100, thereby correcting the change of the deflection magnetic field.

In FIG. 11, the screen section portion 110 has the wire portion 130, which is deformed in shape to form the wire curved-surface portion 120, thereby enhancing the deflection magnetic field. In this case, the wire portion 130 is upwardly pushed at both sides thereof in a window direction, thereby obtaining the ‘W’-shape or ‘M’ shape. Owing to the ‘W’-shape or ‘M’ shape, the wire portion 130 is prevented from being suspended according to its pile, and has a predetermined thickness. That is, the down pressing (pressed direction) of the wire portion 130 is balancingly supported by using the curved-surface part 200 formed by pushing-up the wire portion 130 in the window direction from both sides of the wire curved-surface portion 120.

Referring to FIGS. 12 and 13, the horizontal deflection coil is described as follows.

Referring to FIG. 12 and FIG. 2, a turning pin 23 is used to form the screen bent portion 12a and the neck bent portion 12c. A cylindrical pin 140 is used to form the screen section portion 110 at the middle portion 12b. The cylindrical pin 140 is provided for shaping the wire curved-surface portion 120. An upward support pin 150 is provided at both sides of the horizontal deflection coil to upwardly support in the window direction at both lower sides of the wire curved-surface portion 120. The wire portion 130 is upwardly elevated at both sides of the horizontal deflection coil by the upward support pin 150 to have the predetermined thickness.

As shown in the drawings, even in case where the pin is upwardly deformed by a distance of d″ to deform the screen bent portion 12a, the wire portion 130 of the wire curved-surface portion 120 is not deformed, thereby constantly maintaining the middle portion 12b at which the main deflection magnetic field is generated.

The above-described horizontal deflection coil 100 is made using a mold of the deflection-coil winder shown in FIG. 13. The mold is comprised of a guide part 160 and a shape part 170. The turning pin 23 is protruded such that the guide part 160 guides a wire introduced into the mold to shape the wire in a predetermined shape. The shape part 170 has pins, which are protruded to shape the wire guided into the mold into a predetermined shape. As shown in FIG. 12, the cylindrical pin 140 and the upward support pin 150 are used as the above-shaped pins. The cylindrical pin 140 has the same shape as the turning pin 23. The turning pin 23 and the cylindrical pin 140 have a difference in function. In other words, the turning pin 23 is to guide the wire introduced into the mold, whereas the cylindrical pin 140 is to deform the introduced wire in the predetermined shape to form the screen section portion.

Further, the cylindrical pin 140 and the upward support pin 150 are disposed at the shape part 170 to shape the screen section portion 110 and the wire portion 130. The cylindrical pin 140 and the upward support pin 150 are not limited in number and position, and can be changed in position and number according to production environment and scattering.

The upward support pin 150 and the cylindrical pin 140 shown in FIG. 14 have a different shape depending on pin function. As shown in FIG. 14, the cylindrical pin 140 has a trunk portion 210 having a cylindrical body. The trunk portion 210 has an upper end tapered. The tapered upper end allows the wire introduced into the mold to have the predetermined shape due to the protruded cylindrical pin 140. The shape of the wire using the cylindrical pin 140 allows the wire curved-surface portion 120 to have a middle groove of ‘M’ or ‘W’ due to the protruded pin.

In the meantime, the upward support pin 150 shown in FIG. 14B includes a center part 190 and a wing part 180 provided at both sides of the center part 190. The wing part 180 is upwardly deflected at a predetermined angle with a predetermined thickness. The center part 190 is provided higher than the wing part 180, and its upper part is deflected at a predetermined angle. This shape allows the wire portion 130 to be pushed up in the window direction after the wire is wound, that is, after the wire portion 130 is formed. However, the cylindrical pin 140 or the upward support pin 150 is not limited to the above shape, and can be deformed depending on their functions. Further, the upward support pin 150 has an operational difference in that after the provision of the wire portion 130, the upward support pin 150 is protruded upwardly of the mold such that the wire portion 130 is pushed up in the window direction, unlike other cylindrical pins 140 or turning pins 23 protruded when the wire is wound.

In order to provide the horizontal deflection coil 100, a number ratio is required to have the number of the cylindrical pin 140 less than or the same as the number of the upward support pin 150. This is because the upward support pin 150 has the purpose of preventing the wire portion 130 from being suspended when the wire is piled due to the cylindrical pin 140. Accordingly, there is an advantage in that the wire portion 130 is pushed up in the window direction due to the upward support pin 150, thereby maintaining the wire portion 130 to always have a constant thickness.

The above advantage allows the middle portion 12b of the horizontal deflection coil 100, which generates the main deflection magnetic field, to always have a constant shape such that two horizontal deflection coils 100 inserted into the deflection yoke can be maintained to have the same shape. Therefore, there is an advantage in that the scattering is reduced, thereby increasing an efficiency of the deflection magnetic field.

In order to provide more preferable effect, the curved-surface part 200 has an angle greater than 90° and less than or equal to 180°, and the middle of the wire portion 130 has an angle greater than or equal to 180° and less than 270°.

The present invention is described mainly referring to the horizontal deflection coil 100, but is not limited to the horizontal deflection coil and can be apparently applied even to a manufacture process of the horizontal deflection coil. For example, in a saddle shaped deflection yoke, a vertical deflection coil can also increase the efficiency of the deflection magnetic field by deforming the middle portion 12b of the deflection coil.

FIG. 15 illustrates the horizontal deflection coil 100 mounted on the deflection yoke according to the present invention. The present invention provides two horizontal deflection coils 100, which are symmetric to each other within the deflection yoke 1. By providing two curved-surface parts 200 using the upward support pin 150 at both sides of the wire curved-surface portion 120, the horizontal deflection coil 100 has the wire portion 130 disposed at the middle portion 12b and having the constant thickness, thereby providing the middle portion 12b having the always constant shape. Accordingly, two horizontal deflection coils 100 disposed within the deflection yoke 1 have four middle portions 12b, which have a predetermined shape and are symmetric, to apply a constant deflection magnetic field to beam passing through the deflection yoke, thereby improving the efficiency of the magnetic field of the deflection yoke.

The shape of the middle portion 12b for generating the magnetic field to deflect electron beam can be constantly maintained using the deflection yoke. Due to this characteristic, misconvergence of the electron beam can be corrected, thereby appropriately corresponding to the wide-angle and the flat of a cathode ray tube.

The present invention has an effect in that the horizontal deflection coil is wound using the above-constructed deflection-coil winder, thereby constantly maintaining the wire distribution of the middle portion, which substantially affects the deflection magnetic field.

Further, the present invention has an effect in that even though a position of the turning pin is changed on a screen portion to adjust the distribution of a screen wire, it does not affect the distribution of a middle portion wire, thereby barreling N/S distortion and improving the efficiency of the deflection magnetic field.

Furthermore, the present invention has an effect in that the distribution of the middle portion wire can be constantly maintained at the time of the production of the horizontal deflection coil, thereby increasing a reliability of the product.

It will be apparent to those skilled in the art that various modifications and variations can be made in the present invention. Thus, it is intended that the present invention covers the modifications and variations of this invention provided they come within the scope of the appended claims and their equivalents.

1. A horizontal deflection coil for a deflection yoke, comprising:
a screen bent portion;
a middle portion having a screen section portion for generating a main deflection magnetic field, the screen section portion including at least one wire curved-surface portion; and
a neck bent portion,
wherein a wire portion shaped in a letter ‘M’ or ‘W’ is piled centering on the wire curved-surface portion.

2. The horizontal deflection coil of claim 1, wherein the middle portion has an identical shape with respect to a symmetric axis of the horizontal deflection coil.

3. The horizontal deflection coil of claim 1, wherein the wire portion piled in a downward direction of the screen section portion has a groove at a middle portion thereof, the groove is formed using a cylindrical pin, and an upward support pin is used to form both sides of the wire portion.

4. The horizontal deflection coil of claim 3, wherein the upward support pin is formed at a predetermined portion of a mold of a deflection coil winder, and is used to push the piled wire portion in an upward direction (or window direction) by a predetermined distance.

5. The horizontal deflection coil of claim 3, wherein the upward support pin comprises both wing parts and a center part, the wing parts have a predetermined thickness and are tapered in an upward direction, and the center part is located higher than the wing parts and has an upper portion tapered at a predetermined angle.

6. The horizontal deflection coil of claim 3, wherein the cylindrical pin is used for maintaining a shape of the wire portion, and the number of the cylindrical pin is less than or equal to the number of the upward support pin used for maintaining the shape of the wire portion.

7. The horizontal deflection coil of claim 3, wherein the both sides of the wire portion formed by the upward support pin have an angle less than or equal to 180° and more than 90° in the window direction, and the center part of the wire portion formed by the cylindrical pin has an angle greater than or equal to 180° and less than 270° in the window direction.

8. A vertical deflection coil for a deflection yoke, comprising:
a screen bent portion;
a middle portion having a screen section portion for generating a main deflection magnetic field, the screen section portion including at least one wire curved-surface portion; and
a neck bent portion,
wherein a wire portion shaped in a letter ‘M’ or ‘W’ is piled centering on the wire curved-surface portion.

9. The vertical deflection coil of claim 8, wherein the wire portion piled in a downward direction of the screen section portion has a groove at a middle portion thereof, the groove is formed using a cylindrical pin, and an upward support pin is used to form both sides of the wire portion.

10. A winder for a deflection yoke, comprising:
a mold having a screen portion and a neck portion at a front side and a rear side thereof, and designed in a semiconical shape to form a portion where a deflection magnetic field of a deflection coil is generated;
two or more turning pins protruded from the screen portion of the mold, for guiding a coil wire such that the deflection coil is formed having a predetermined shape;
a cylindrical pin protruded from a winding portion of the mold, and having a screen section portion formed at a middle portion of the deflection coil, for correcting a magnetic field of a middle portion of the deflection coil; and
an upward support pin protruded from the winding portion of the mold and pushing a wire portion piled by the cylindrical pin in a window direction such that the wire portion is formed having a predetermined thickness at a predetermined position.

11. The winder of claim 10, wherein the number of the upward support pin is greater than or equal to the number of the cylindrical pin.

12. A deflection yoke comprising:
a coil separator including a screen portion and a rear cover, which are coupled to a screen of a cathode ray tube, and a neck portion integrally extending from a central face of the rear cover and coupled to an electron gun portion of the cathode ray tube;
two horizontal deflection coils of claim 1 disposed on an inner surface of the coil separator, for forming a horizontal magnetic field;
a vertical deflection coil of claim 8 disposed on an outer surface of the coil separator and formed on a ferrite core so as to form a vertical deflection magnetic field.

13. The deflection yoke of claim 12, wherein the horizontal deflection coil of claim 1, provided at an inner surface of the coil separator is two, the vertical deflection coil of claim 8, provided at an outer surface of the coil separator is two, and the two horizontal deflection coil and the vertical deflection coil have middle portions, which have an identical shape and are formed symmetric, thereby maintaining a predetermined shape.
